(19) United States
(12) Patent Application Publication
(10) Pub. No.: US 2006/0064821 A1
(43) Pub. Date: Mar. 30, 2006

(54) Cuddle cradle

(76) Inventor: Gregory Darnell Pruitt, Indianapolis, IN (US)

Correspondence Address: Mr. Gregory Pruitt, PO Box 533137, Indianapolis, IN, 46253-3137, US

(21) Appl. No.: 10/953,058

(22) Filed: Sep. 30, 2004

(51) Int. Cl. A61G 7/00

(52) U.S. Cl. 5/731; 5/929

(57) ABSTRACT

A hallow cuddling device that is used in conjunction with a pillow, a apparatus that elevates and supports the head and neck while creating a real sense of relieve to the extremities such as the shoulders and arms. The ergonomically designed cuddling device designed to alleviate the discomfort and relieve all or any discomfort in the neck, shoulder, or arms associated with cuddling such as poor circulation, sore muscles, fatigue, stiffness, numbness, cramping. The cuddle cradle's design allows for two individuals to cuddle and or rest comfortable in a variety of positions such as lying on their sides, spine or any of the combination This also allows for from of movement for the upper arms, elbows, forearms, wrists, hands, and fingers. A cuddling device that promotes a genuine sense of closeness between two individuals.

### REFERENCES IN THE RESEARCH OF INVENTION

1. Invention Submission Corporation (ISC) Research Development Department 217 Ninth Street Pittsburgh, Pa. 15222-3506 Tel: 412.288.1300 Client Condidential File: #INY-232
2. Thomas Frost, P.A. 6600 Fouth Street North Suite 102 Saint Petersburg, Fla. 33702 Tel: 727.525.9229 Fax: 727.525.9449

### BACKGROUND OF THE INVENTION

Pillows are devices used to support the head, only to lose their firmness after just a few uses. Head support devices are apparatus' that are too rigid to enjoy without the firmness and help of a standard pillow. Both typically are used when resting, relaxing, or enjoying the company of a significant other. Thus, when used the devices are supposed to relieve or prevent the user from any discomfort while the arms are underneath the apparatus which further leads to restricted movement of the arm underneath the apparatus which cause poor circulation, sore muscles, fatigue, stiffness, numbness, cramping, and any discomfort associated with cuddling, lying on one's side, or in a supine position. Additionally, Both devices when made as one unit tend to create a host of problems.

### BRIEF SUMMARY OF THE INVENTION

The Cuddle Cradle is an apparatus which support one's head and neck, while having a ergonomically designed head, neck, shoulder, and arm support and relief system. While the head and neck are supported by the ergonomically design, the shoulders and arms enjoy the relief system due to the head and neck weight being supported by the apparatus. The apparatus is intentionally left hollow underneath and open on the right, left, and partially open in front for air circulation. Additionally, the apparatus can be used by one individual lying on their side or in the supine position, but the primary function of the apparatus can be used as a cuddling device with a significant other while both are in the supine or side positions.

The Cuddle Cradle was designed to alleviate the discomfort and relieve all or any discomfort in the neck, shoulder, or arms associated with cuddling such as poor circulation, sore muscles, fatigue stiffness numbness, cramping For example, while a couple is cuddling the holder usually feels the cramping and sore effects of cuddling relatively in about ten to fifteen minuets due to poor blood circulation on account of the bearing head weight of the holdee Unfortunately, the effects of cuddling can cause nerve, muscle, tissue, and joint damage as a direct or indirect cause of cuddling without a cradling device.

Additionally, the Cuddle Cradle could be produced easily using conventional and available materials and manufacturing process. The Cuddle Cradle could be produced by any of the 7,300 manufactures of wood products by hand to the predetermined design specifications, and then sanded and stained or by any of the 8,573 manufactures of of plastics products in the form of injection-molded polystyrene which could be made with clear plastics with designs inside, different sizes, shapes, and color or any of the combination for couples, parents or grandparents with children, for anyone and for everyone.

### BRIEF DESCRIPTION OF THE SEVERAL VIEWS OF THE DRAWINGS AND PICTURES

### The Cradle's Prospective View

### (Numbers are on the Back of the Pictures)

Picture 1 is a 3D view of the front-side of the right-arm Cuddle Cradle. (shown is the main board, shortboard, and longboard)

Picture 2 is a 3D view of the right-side of the right-arm Cuddle Cradle. (shown is the main board, shortboard, and longboard)

Picture 3 is a 3D view of the back-side of the right-arm Cuddle Cradle. (shown is the main board and longboard)

Picture 4 is a 3D view of the left-side of the right-arm Cuddle Cradle. (shown is the main board and longboard)

Picture 5 is a 3D view of the front-side of the left-arm Cuddle Cradle. (shown is the main board, shortboard, and longboard)

Picture 6 is a 3D view of the left-side of the left-arm Cuddle Cradle. (shown is the main board, shortboard, and longboard)

Picture 7 is a 3D view of the back-side of the left-arm Cuddle Cradle. (shown is the main board and longboard)

Picture 8 is a 3D view of the right-side of the left-arm Cuddle Cradle. (shown is the main board and longboard)

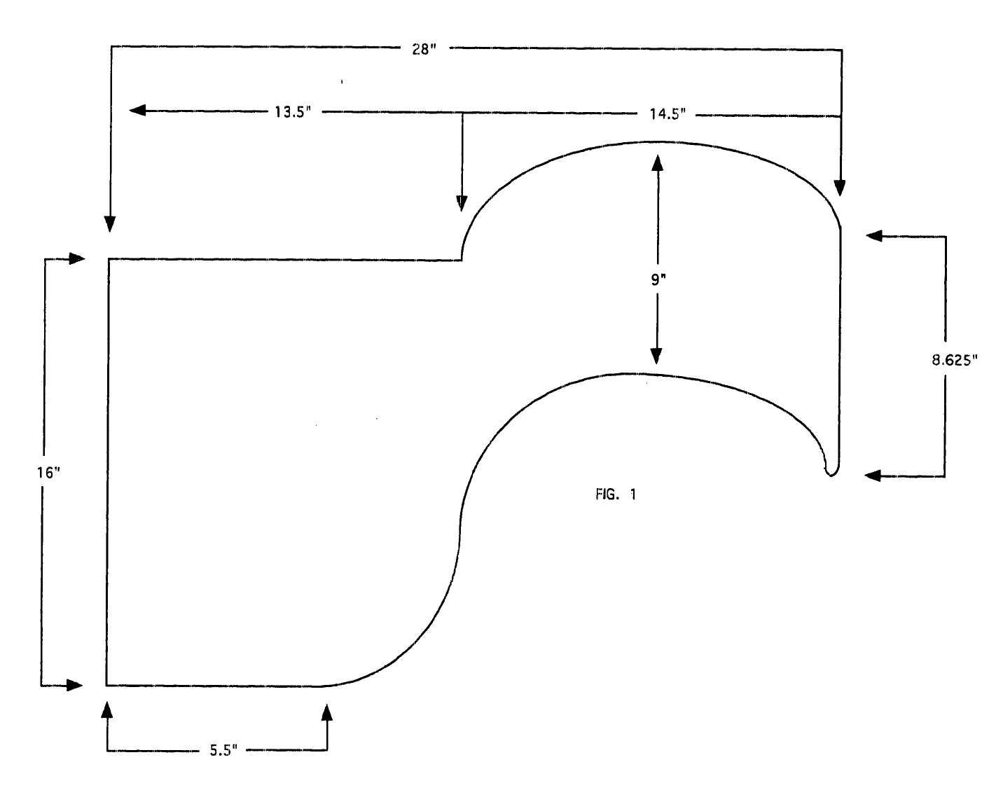

FIG. 1 is the dimensions for the right-side Cuddle Cradle.

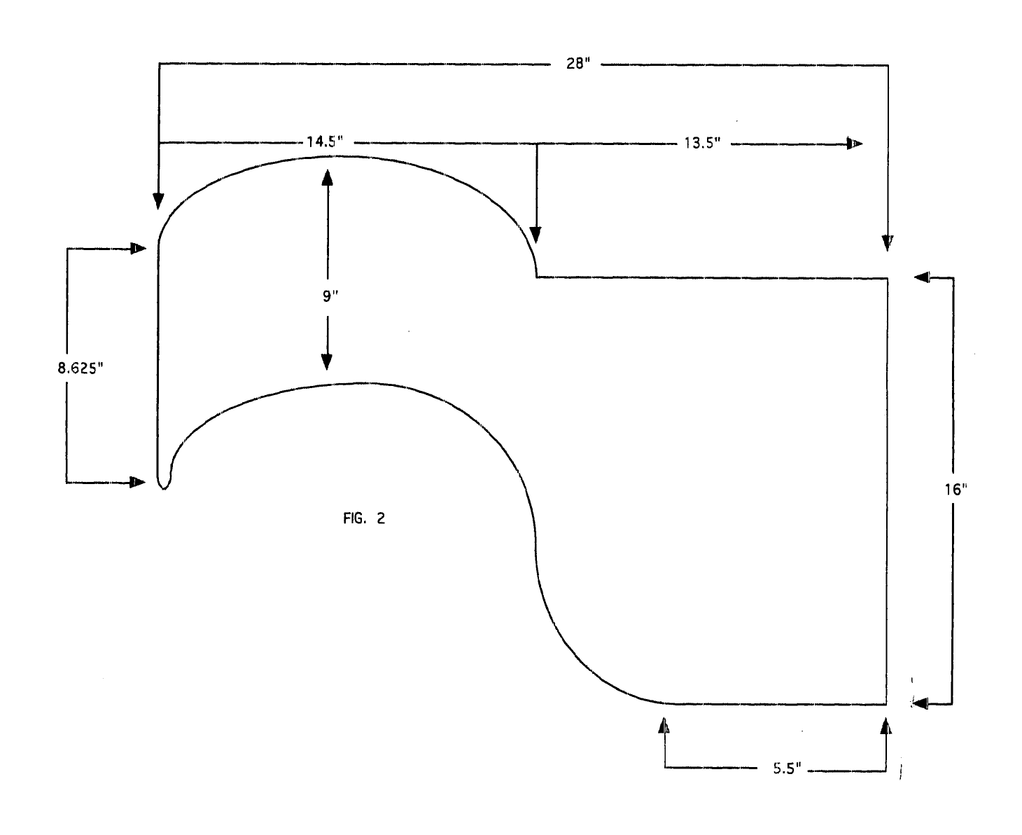

FIG. 2 is the dimensions for the left-side Cuddle Cradle.

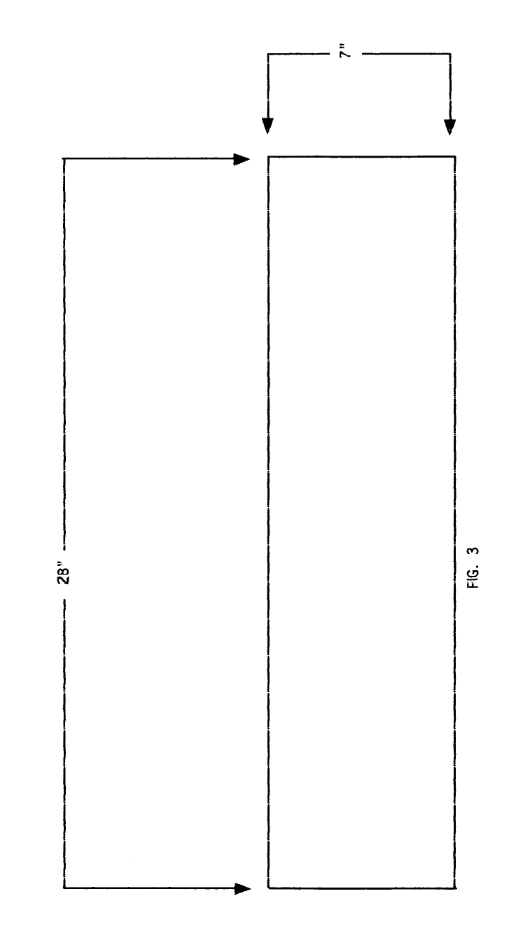

FIG. 3 is the dimensions for the longboard for both right and left Cuddle Cradle.

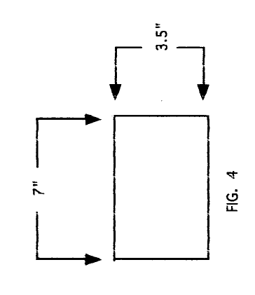

FIG. 4 is the dimensions for the shortboard for both right and left Cuddle Cradle.

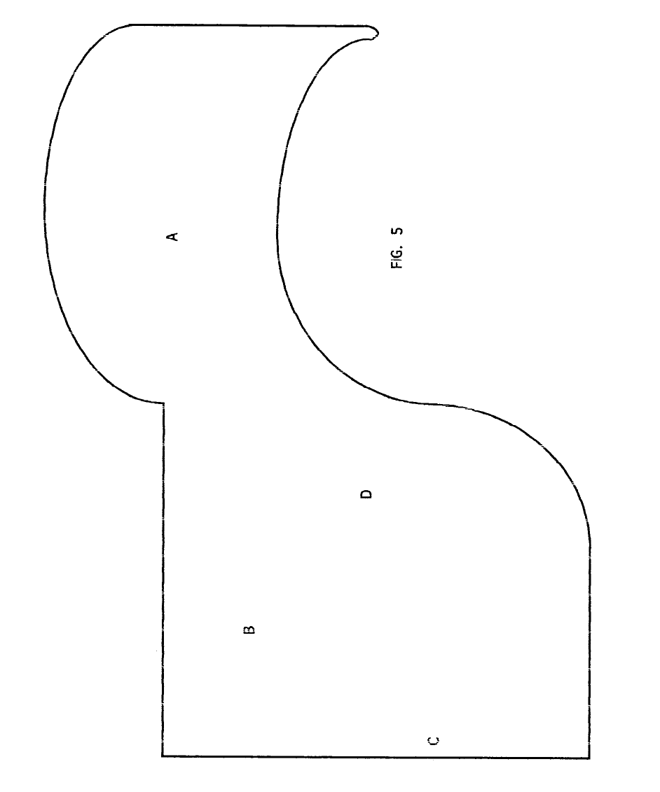

FIG. 5 is the for the right-side Cuddle Cradle without dimensions.

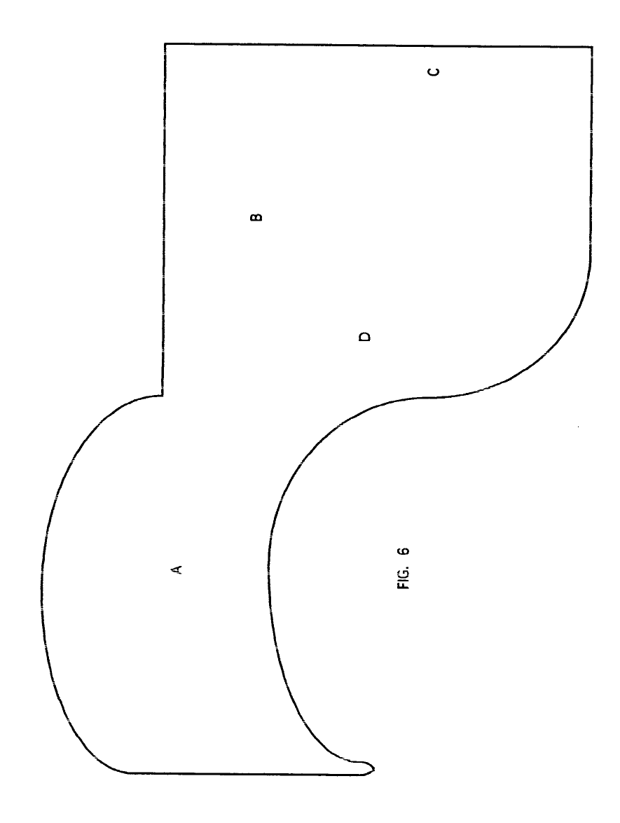

FIG. 6 is the for the left-side Cuddle Cradle without dimensions.

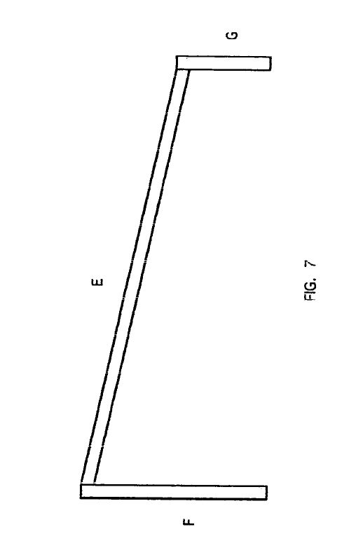

FIG. 7 is the ergonomically designed head and neck tilt.

### DETAILED DESCRIPTION OF THE INVENTION

FIG. 1 is the full dimensions to the right-arm cuddle cradle.

FIG. 2 is the full dimensions to the left-arm cuddle cradle.

FIG. 3 is the full dimensions to the longboard to both right and left-arm cradles.

FIG. 4 is the full dimensions to the short board to both right and left-arm cradles.

FIGS. 5 & 6 displays (A) the head placement of the holder and placement of the holder's arm underneath the apparatus (B); head placement of the holdee (D), and the arm of the holdee underneath the apparatus (C). Either applies to the right or left cuddle cradle.

FIG. 7 displays the ergonomically designed tilt for both partners head and neck.

Additionally, the Cuddle Cradle could be produced easily using conventional and available materials and manufacturing process. The Cuddle Cradle could be produced by any of the 7,300 manufactures of wood products by hand to the predetermined design specifications, and then sanded and stained or by any of the 8,573 manufactures of of plastics products in the form of injection-molded polystyrene.

1. (canceled)

2. (canceled)

3. (canceled)

4. (canceled)

5. What I claim as my invention is: the functional/structural purpose of the cuddle cradle, as shown and described.
